(19) United States
(12) Patent Application Publication
(10) Pub. No.: US 2026/0336252 A1
(43) Pub. Date: Oct. 29, 2026

(54) NEEDLE-STICK RESISTANT MATERIAL AND GARMENT COMPRISING SAME

(71) Applicant: TRIUS SAFETY, NARBONNE (FR)

(72) Inventors: Stéphane GRIEU, CRUSCADES (FR); Mohammed EL AZZOUZI, MONTPELLIER (FR)

(21) Appl. No.: 19/119,743

(22) PCT Filed: Oct. 24, 2022
(86) PCT No.: PCT/FR2022/052011

§ 371 Date: Apr. 9, 2025

(30) Foreign Application Priority Data
Oct. 25, 2021 (FR) FR2111329

(51) Int. Cl. B32B 3/16; A41D 19/015; B32B 3/26; B32B 7/05; B32B 7/08

(52) U.S. Cl. CPC B32B 3/16; A41D 19/01505; B32B 3/266; B32B 7/05; B32B 7/08; B32B 2437/02; B32B 2571/02

(57) ABSTRACT

A material having a superposition of at least three layers, a lower layer, at least one intermediate layer and an upper layer. Each layer includes: a plurality of platelets arranged in a juxtaposed manner to form a paving with a clearance between the platelets, and a connector joining the platelets together. At least three layers are superposed with one another such that the platelets of one layer are offset relative to the platelets of the other layers so as to eliminate all of the openings in the material. Each platelet of the upper layer has a local thickening at an outer periphery of each platelet.

### TECHNICAL FIELD OF THE INVENTION

The present invention relates to a material capable of protecting against needle-sticks and to articles of clothing comprising such material.

The present invention is in the field of protecting a part of a human body from the risks of needle-sticks, in particular syringe needle-sticks.

A particular field of application of the invention is the protection of hands against the risk of punctures, particularly those made by hypodermic syringe needles.

### PRIOR TECHNIQUE

Commercially available protective gloves are primarily resistant to cuts, punctures, abrasion and/or tearing. But very few gloves protect the hands against the risk of needle sticks. However, for many professions, such as maintenance workers, waste sorting center workers, garbage collectors, horticulturists in public parks, the accidental risks of being pricked by a used syringe needle occur currently.

Among the protective gloves on the market that provide protection for hands against the risk of needle sticks, we can mention the gloves of the HexArmor® brand, which uses SuperFabric® technology.

However, these protective gloves have a certain rigidity that hinders the freedom of movement of the fingers of a user's hand. Handling objects with such protective gloves is difficult, and their use is ultimately uncomfortable for the user.

### PRESENTATION OF THE INVENTION

The present invention is intended to remedy the disadvantages of the solutions proposed by the prior art, particularly those described above, by providing a material capable of providing very effective protection against the risk of needle-sticks, while ensuring flexibility, allowing it to be used in the manufacture of protective articles of clothing.

An article of clothing is an article used to cover a part of the human body. As non-exhaustive examples, an article of clothing can be trousers, a jacket, a glove, an apron, a shoe.

For this purpose, the present invention proposes a material comprising a superposition of at least three layers, a lower layer, at least one intermediate layer and an upper layer, each of the at least three layers comprising:
a plurality of platelets arranged in a juxtaposed manner while forming a paving, with a clearance between said platelets,
means for connecting the platelets together.

The at least three layers are preferentially distinct from each other. The means for connecting the platelets of one of the at least three layers is preferably distinct from the means for connecting the platelets of each of the other layers.

The at least three layers are superimposed on each other so that the platelets of one layer are offset with respect to the platelets of the other layers so as to remove all the openings in the material.

In other words, the different layers of the material are superimposed on each other, shifting the paving of the intermediate and upper layers offset from one another and from the paving of the lower layer so as to cover the entire clearance between the platelets forming the paving of the lower layer.

When all the layers of the material are superimposed, no opening passing through the total thickness of the material is visible. In other words, there is no possible vertical path (i.e., in the thickness) through the material.

The suppression of the openings depends notably on the patterns of the platelets forming the paving, the clearance between the platelets and the way in which the platelets of the different layers are superimposed on each other.

The connecting means of a layer makes it advantageous to maintain the clearance imposed between the platelets of said layer. Such connecting means also advantageously provides flexibility to the associated layer, and therefore flexibility to the material.

Such a flexible material advantageously combines protection, especially against needle-stick, resistance, comfort and dexterity.

Each platelet of the upper layer has a local thickening at an outer periphery of the platelet. This local thickening for each platelet of the upper layer advantageously blocks the penetration of a skewed needle which could slide between the layers. Thus, when a needle arrives at an angle on one of the platelets of the upper layer, the local thickening of said platelet allows the needle to be blocked at the level of said platelet and thus prevents it from penetrating the material with an angle.

The thickening is preferably carried out at the level of a face opposite a face facing an intermediate layer

In particular embodiments, the material may also have one or more of the following features, taken in isolation or in all technically feasible combinations.

According to special embodiments, the connecting means of a layer is a fabric and the platelets are securely bonded to the fabric. Preferably, the connecting means all the layers is a fabric, and the platelets of each layer are securely bonded to the fabric.

In particular forms of realization, to advantageously limit the detachment of the platelets from the fabric of a layer, said fabric is trapped within a thickness of the set of the platelets of said layer.

In preferred embodiment examples of the invention, the fabric is a tulle.

In preferred embodiments of the invention, to prevent the layers from slipping in relation to each other, the at least three layers are fixedly secured together. The at least three layers are mechanically bonded together, with no degrees of freedom.

Preferably, the at least three layers are punctually fixedly secured together.

In preferred embodiments of the invention, the lower layer includes studs arranged in some platelets, and the other layers include through orifices for receiving said studs.

Preferably, the platelets of each layer forming the material have a local thickening at an outer periphery of the platelet.

In examples of embodiments of the invention, the platelets of a layer are geometrically shaped as three hexagons each joined together each at the level of two adjacent edges. A paving formed by such platelets has the advantage of presenting no privileged axis of weakness. A material comprising at least one layer with such a paving is advantageously resistant to cuts.

Preferably, all layers of the material have the same paving.

In preferred embodiments of the invention, the platelets of the layers are made by 3D printing. 3D printing offers the advantage to be able to create platelets patterns of different shapes, of small dimension. By small dimension, we mean patterns that fit within a circle with a diameter of around one centimeter.

The invention also relates to an article of clothing comprising a material conforming to at least one of its embodiments. The material can form an insert in the article of clothing, and is usually placed between an inner layer, called a lining, intended to be opposite a part of a user's body, and an outer layer, called an exterior covering.

The material may be in the form of a single piece, or several independent pieces, arranged in one or more parts of the article of clothing, corresponding to one or more areas of the user's body that need to be protected by the material.

Preferably, the inner and/or outer layer of the article of clothing s a textile. The material is preferably assembled by sewing to the inner and/or outer layer of the article of clothing.

In particular embodiments, the article is made in the form of a protective glove. Such a glove can be used by users who need to wear needle-stick resistant gloves while maintaining adequate manual dexterity and tactile sensitivity.

### BRIEF DESCRIPTION OF THE FIGURES

The invention will be better understood by reading the following description, given by way of example, in no way restrictive, and made with reference to the following figures:

FIG. 1 represents a perspective view of a material according to an embodiment of the invention;

FIG. 2 represents a photography of a layer of a material according to an embodiment of the invention;

FIG. 3 schematically represents the three steps of superimposing three layers of a material to suppress the openings;

FIG. 4 shows a top view of a material with three superimposed layers;

FIG. 5 shows a perspective view of a lower layer of the material, illustrating the studs;

FIG. 6 shows a top view of an upper layer of the material illustrating the complementary through orifices of the studs of the lower layer in FIG. 5;

FIG. 7 shows a perspective view of a layer of the material, e.g. the top layer, illustrating the means for connecting the platelets of the layer and the local thickening on the platelets;

FIG. 8 schematically represents a glove comprising a material according to the invention.

In these figures, identical numerical references from one figure to another designate identical or analogous elements. Also, for clarity, the drawings are not to scale, unless otherwise stated.

### DESCRIPTION OF THE METHODS OF EMBODIMENT

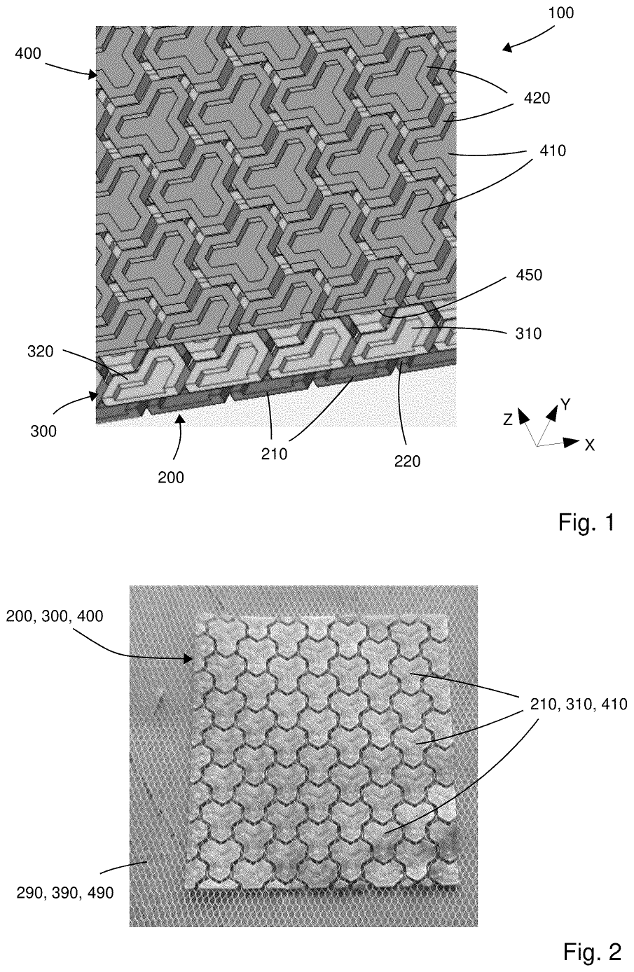

An example of a material 100 according to the present invention is now described and illustrated in FIGS. 1 to 7. The material 100 is a multi-layer material for protection against needle sticks, in particular hypodermic syringe needle sticks.

The material 100 is in the form of at least three superimposed layers: a lower layer 200, an upper layer 400, and at least one intermediate layer 300.

In the rest of the description, the material 100 is described and illustrated, in a non-exhaustive manner, in a preferred embodiment configuration where it has three layers: one lower layer 200, one intermediate layer 300 and one upper layer 400, as shown in FIG. 1. If the material 100 has several intermediate layers, these are preferentially identical to each other.

Each layer 200, 300, 400 of the material 100 comprises, as illustrated by way of example in the photography in FIG. 2:
a plurality of platelets 210, 310, 410 arranged in a juxtaposed manner forming a paving, with a clearance between said platelets,
means 290, 390, 490 for connecting the platelets 210, 310, 410 to each other.

The three layers are preferentially distinct from each other. The means for connecting the platelets of each layer are preferentially distinct from each other.

For each layer 200, 300, 400, the platelets 210, 310, 410 are arranged next to each other, on the same plane, without overlapping, leaving a defined space between them, so that the platelets 210, 310, 410 constitute a regular or semi-regular paving.

The platelets 210, 310, 410 of a layer 200, 300, 400 preferentially have the same thickness. The thickness of a platelet 210, 310, 410 represents the dimension that is perpendicular to the plane. The platelets 210, 310, 410 of each layer 200, 300, 400 of the material 100 preferably have the same thickness. The platelets 210, 310, 410 of each layer 200, 300, 400 of the material 100 preferably have a thickness of at least 0.5 mm.

The clearance between the platelets 210, 310, 410 of a layer 200, 300, 400 is preferably a regular clearance, as shown in FIG. 2. Regular clearance means that the space between two adjacent platelets is constant and identical for the entire layer.

Preferably, the clearance between the platelets 210, 310, 410 of a layer 200, 300, 400 is at least equal to twice the thickness of the platelets, thus allowing said layer to be bent and to contribute advantageously to the flexibility of the material 100 containing it.

In a preferred embodiment, as shown in FIG. 1, each layer 200, 300, 400 of the material 100 has the same paving. Such an embodiment has an advantage in terms of the production of the material 100, the superimposed layers being identical, the material 100 is faster to produce.

In another embodiment, at least one layer has a different paving.

In a preferred embodiment configuration, as shown in FIG. 2, the platelets 210, 310, 410 of a layer 200, 300, 400 of the material 100 all have the same pattern, forming the basic pattern. The paving obtained by the juxtaposition of these platelets is called regular paving.

In a non-exhaustive example of an embodiment, the basic pattern is a regular polygon such as a triangle, a square, a hexagon, a diamond.

In another embodiment configuration, the platelets 210, 310, 410 of a layer 200, 300, 400 have at least two different patterns, said at least two different patterns forming the basic pattern. The paving obtained by the juxtaposition of these platelets is called semi-regular paving.

In an example of an embodiment, a basic pattern consists of two polygons, such as a hexagon and a diamond.

In an example of an embodiment of the material 100, shown in FIGS. 1 and 2, the material 100 has three layers 200, 300, 400. Each layer of the material 100 has an identical regular paving, with the same basic pattern. The basic pattern has the overall geometric shape of three hexagons joined together two by two. Each hexagon is adjoined to the other two hexagons at two adjacent edges. This basic pattern is called Tri-Hex®. A paving based on such a basic pattern has the advantage, unlike a paving based on a square basic pattern, of having no preferred axis of weakness, and is therefore resistant to cuts.

According to the invention, the layers 200, 300, 400 forming the material 100 are superimposed on each other so that all the platelets 210, 310, 410 of a layer 200, 300, 400 are offset in relation to the platelets of the other layers to suppress all the openings in the material 100.

An opening corresponds to a through hole in the material 100, transversely to the total thickness of said material, without encountering platelets of any of the layers constituting it. This hole is called opening because it allows, among other things, the passage of light.

In other words, the different layers 200, 300, 400 of the material 100 are superimposed on each other, by offsetting the platelets of the intermediate layer 300 and the upper layer 400 from the lower layer 200 so as to cover the entire clearance between the platelets forming the paving of the lower layer 200.

The paving of the intermediate layer 300 is thus offset with respect to the paving of the lower layer 200 to cover part of the clearance between the platelets 210 forming the paving of the lower layer 200. Then the paving of the upper layer 400 is offset in relation to the platelets of the intermediate layer 300 and the lower layer 200 to cover the rest of the clearance between the platelets 210 forming the paving of the lower layer 200.

When the three layers 200, 300, 400 are superimposed, no opening through the total thickness of the material 100 are visible.

The offset of the paving of one layer relative to another layer is an offset of the paving of the layer in its plane, parallel to the plane of the paving of the other layer. The offset can be achieved by translation and/or rotation.

The skilled person can determine the necessary offset of the paving of the intermediate and upper layers, according to the pattern of the paving and the clearance between the platelets, to fill in the set of openings of the material 100.

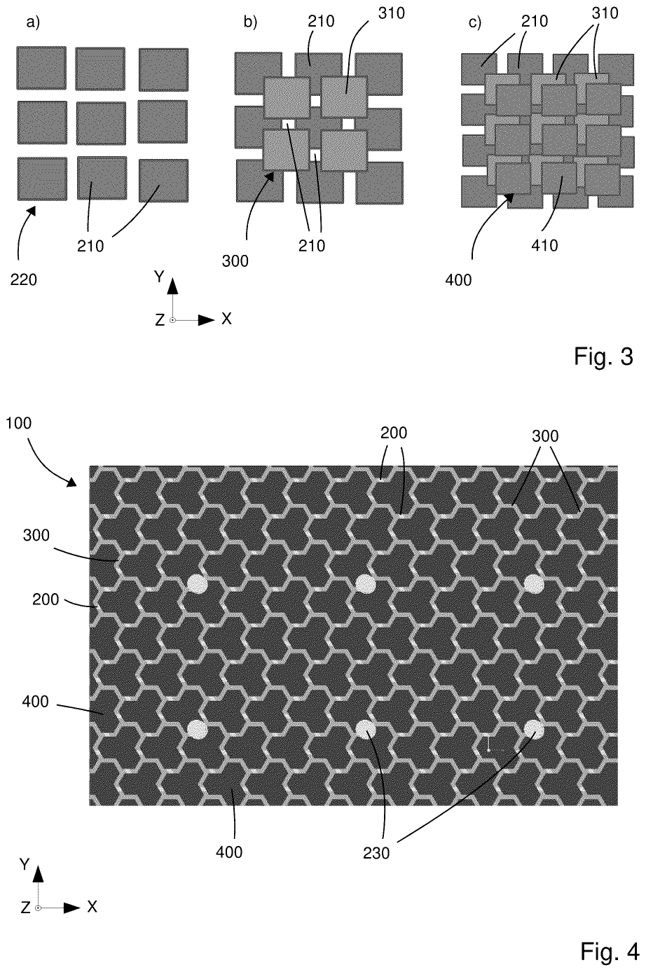

FIG. 3 illustrates a simplified example of the superposition of three layers 200, 300, 400, each layer having a paving made with identical platelets, with a square pattern. Image a) in FIG. 3 shows the paving of the lower layer 200, with nine platelets 210. Image b) in FIG. 3 shows the positioning of a portion of the intermediate layer 300 on the lower layer 200. The paving of the intermediate layer 300, partially represented by four platelets 310, is shifted in X and Y, so as to cover part of the clearance between the platelets forming the paving of the lower layer 200. Openings 700, here square in shape, are still visible. Image c) in FIG. 3 shows the positioning of a portion of the top layer 400 on the intermediate layer 300. The paving of the upper layer 400, represented in part by nine platelets 410, is shifted in X and Y to cover the remaining openings, i.e. the visible remaining part of the clearance between the platelets 210 forming the paving of the lower layer 200, after the positioning of the intermediate layer 300.

FIG. 4 shows a top view of an example of a material 100 with three superimposed layers, each layer featuring a paving made with identical platelets, with a tri-Hex® pattern. In this non-exhaustive example, the platelets of each layer are inscribed in a circle of 6 mm in diameter, are 0.5 mm thick, and the clearance between the platelets is 1 mm. The black parts represent the upper layer 400, the gray parts represent the intermediate layer 300, and the light gray parts represent the lower layer 200. Areas of the material 100 where there is only one layer in thickness accounts for 16% of the total surface area, those where there are two layers account for 40% of the total surface area and those where there are three layers account for 44% of the total surface area.

In a preferred embodiment, to prevent layers 200, 300, 400 of the material 100 from slipping between each other, and thus avoid the offset between the layers that would create openings, the three layers are fixedly secured together.

By fixedly secured together, we mean that the three layers 200, 300, 400 are mechanically bonded together, with no degrees of freedom.

In an example of an embodiment, the layers 200, 300, 400 of the material 100 are coated together with a protective coating. The coating consists of a step of applying the protective coating in liquid form and then a drying step.

Preferably, the three layers 200, 300, 400 are punctually fixedly secured together.

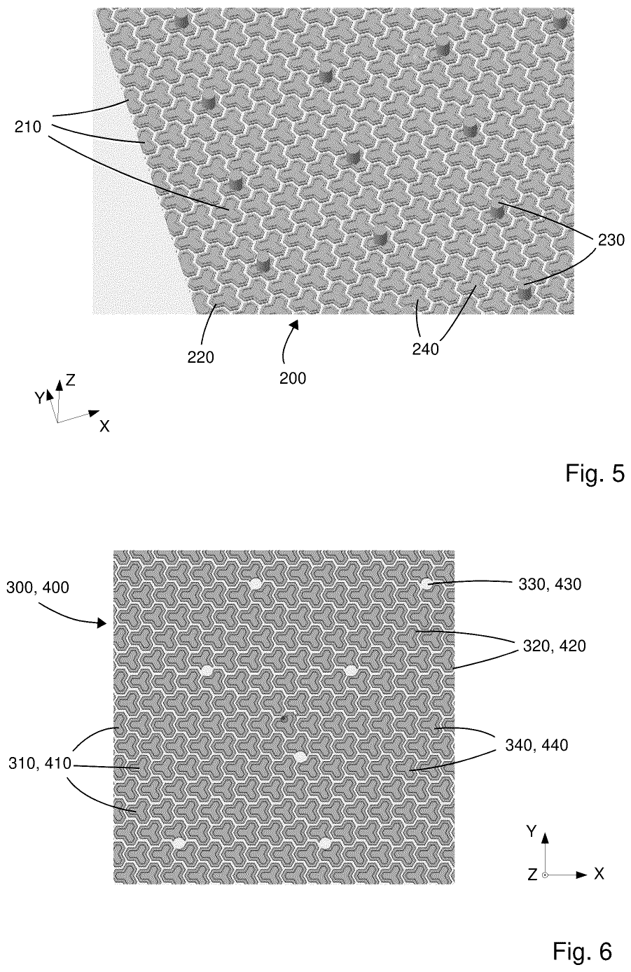

In a preferred embodiment, the lower layer 200 has studs 230 arranged on some platelets 210, as shown in FIG. 5. The studs 230 extend from one face, known as the first face 240, located facing the intermediate layer 300. The studs 230 are sized in length to be greater than the sum of the thickness of the intermediate layer 300 and the thickness of the upper layer 400. When we talk about the thickness of a layer, whatever it may be, we understand that it is the thickness of the platelets of said layer. The studs 230 of the lower layer 200 are also visible in the top view of the material 100 in FIG. 4.

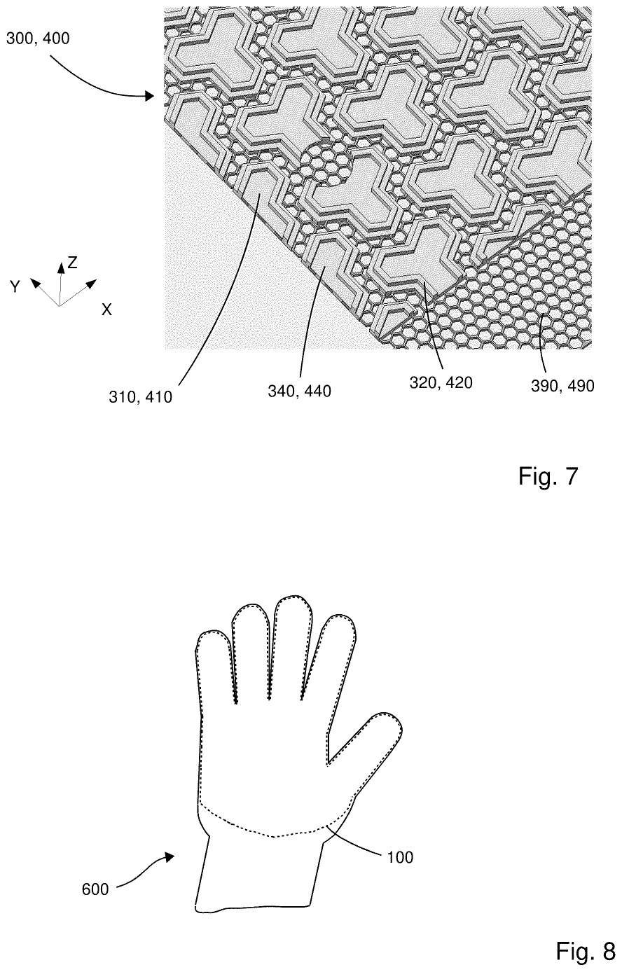

The intermediate layer 300 and the upper layer 400 have through orifices 330, 430 for receiving said studs, as illustrated in FIGS. 6 and 7. The through orifices 330, 430 are arranged on the other two layers 300, 400, so that when the three layers 200, 300, 400 are superimposed on each other, each stud 230 of the lower layer 200 passes through a through orifices 330, 430 of each of the other layers 300, 400. The through orifices 330, 430 are therefore not necessarily located in a platelet 310, 320 but can be located straddling two adjacent platelets of a layer, as illustrated in FIGS. 6 and 7.

The studs 230 of the lower layer 200 are locked at their free ends to prevent the layers from being removed. In an example of an embodiment, the free ends of the studs 230 are welded to the platelets 410 of the upper layer 400.

In a preferred embodiment, as illustrated as an example in FIG. 1, each platelet 410 of the upper layer 400 has a local thickening 420 at the level of an outer periphery of the platelet, e.g. at the outer periphery of the platelet. The local thickening 420 extends preferentially from one face of the platelets, called the first face 440, opposite to a face, called the second face 450, located facing the intermediate layer 300.

Such a local thickening 420 makes it advantageous to block the penetration of a needle obliquely, i.e. at an angle to the plane, by sliding between the platelets of the three layers. This local thickening 420 forms a rampart against the passage of a needle when it arrives at an angle on the upper layer 400, especially when it arrives at an angle on one of the platelets of the upper layer 400. Thus, when a needle arrives at an angle on one of the platelets of the upper layer 400, the local thickening 420 of said platelet blocks the needle at the level of said platelet and thus prevents it from slipping on said platelet and entering the material at an angle, via the clearance between the platelets.

In the example described above where the platelets of each layer of material 100, in a Tri-Hex® pattern, are inscribed in a circle of the order of 6 mm in diameter, and have a thickness of the order of 0.5 mm, the local thickening is of the order of 0.4 mm.

Preferably, the platelets 210, 310, 410 of each layer 200, 300, 400 of the material 100 have a local thickening 220, 320, 420 at the level of their outer periphery, extending from one of the faces of said platelets. In the example in FIG. 1, the local thickening 220 of the platelets 210 of the lower layer 200 extends from the first face 240 of said platelets, the local thickening 320 of the platelets 310 of the intermediate layer 300 extends from a first face 340 of said platelets, facing the upper layer 400, and the local thickening 420 of the platelets 410 of the upper layer 400 extends from the first face 440 of said platelets.

The platelets 210, 310, 410 of each layer 200, 300, 400 are advantageously made of a hard and rigid material.

Preferably, the platelets 210, 310, 410 are preferably made by an additive manufacturing technique, in particular by 3D printing. 3D printing is an additive manufacturing technology where an object is created by successive deposition of layers of material. 3D printing offers the possibility to create any desired shape for platelet patterns.

The material used for the 3D printing of the platelets 210, 310, 410 is preferentially chosen from ABS (Acrylonitrile Butadiene Styrene), PLA (Polylactic Acid), Nylon, or any other material suitable for 3D printing (plastic or metallic).

More preferentially, the material used to produce the platelets 210, 310 and 410 is PLA because it has the advantage of being inexpensive, easy to print, tensile resistant and biodegradable. In addition, a 0.5 mm thick PLA platelet withstands a penetration force of 10 N, with needles with gauges between 26G (0.45 mm diameter) and 18G (0.45 mm diameter). A 0.8 mm thick PLA platelet withstands a penetration force of 20 N, with needles with gauges between 26G and 18G. The penetration force measurement was carried out according to the tests required by the American standard ASTM F2878.

Nylon is also a preferred material because it has good flexibility. In addition, a nylon platelet, 0.8 mm thick, withstands a penetration force of 15 N, with needles with gauges between 26G and 18G.

Other manufacturing techniques are also possible to produce the platelets, such as machining or injection molding, for example, depending on the desired dimensions for the platelets.

As described above, each layer 200, 300, 400 of the material 100 also has means for connecting the platelets 290, 390, 490 to each other. The connecting means 290, 390, 490 makes it possible to maintain the imposed clearance between the platelets of the associated layer. Such connecting means 290, 390, 490 is also advantageously intended to provide flexibility to the associated layer, and thus flexibility to the material 100.

In an example of embodiment, when the platelets 210, 310, 410 of a layer 200, 300, 400 are made by 3D printing, the connecting means 290, 390, 490 can be connections between said platelets, connecting two platelets together, of thin thickness, also made by 3D printing, during the paving of the layer. Preferably, the material for making the platelets and the connecting means between the platelets is nylon, as it provides flexibility to the layer.

It is also possible, with 3D printing, to print a layer with two different materials, a material for the platelets and a material for the connecting means. The material chosen for the connecting means 290, 390, 490 has greater flexibility than the material chosen for the platelets 210, 210, 410, allowing movement between said platelets while keeping them at the correct distance, and the material chosen for the platelets 210, 310, 410 has greater rigidity than the material chosen for the connecting means 290, 390, 490, providing protection against needle sticks. The resulting material 100 is then a composite material, obtained by combining several materials.

In another example of an embodiment, the connecting means 290, 390, 490 is a fabric and the platelets 210, 310, 410 are fixedly bonded to the fabric. The resulting material 100 is then a composite material, obtained by combining several materials.

In one form of embodiment, the platelets 210, 310, 410 rest fixedly on the fabric, for example by gluing or heat sealing.

In a preferred form of embodiment, all the platelets forming the paving of a layer trap the fabric, in their thickness. Such a form of embodiment advantageously limits the detachment of the platelets from the fabric.

When the platelets 210, 310, 410 of a layer 200, 300, 400 are made by 3D printing, for example, the printing is stopped during the production of the platelets, for example at the halfway thickness of the platelets, the fabric is placed on the current platelet layer, then the printing is restarted until the platelets are completely made.

In an example of fabric making, as shown in FIG. 2, fabric 290, 390, 490 can be a tulle. As a reminder, tulle is a light and see-through fabric, for example made of cotton, linen, wool, silk or synthetic fibers, such as polyester, formed by a network of regular meshes of fine threads.

In other examples of fabric making, the fabric can be an openwork fabric (i.e. with hollowed parts), such as a veil, an organza fabric, a tarlatan fabric, etc.

The material 100 according to the invention can be advantageously used in a article of clothing 600, as a lining, to protect a part of the human body.

A preferred area of application for the use of the material 100 in accordance with the invention is the protection of the hands against needle-sticks, via a glove. This field of application is not restrictive of the invention, and the material 100 can be used in any article of clothing, made of textile, leather or polymer material requiring local or total protection against needle-sticks, such as for example a jacket or trousers. The material 100 can also be used in a shoe sole.

The total thickness of the material 100 depends on the final application. This total thickness is approximately equivalent to the sum of the thicknesses of the different layers constituting it.

Preferably, when the material 100 is intended for use in an article of clothing such as a glove, it is preferable that its total thickness does not exceed 3 mm, to ensure its dexterity, comfort, flexibility and lightness. Similarly, it is preferable that the pattern of the platelets be inscribed in a circle with a diameter of less than 10 mm.

The material 100 can have a greater total thickness, when it is intended to be integrated for example into a shoe sole, or an article of clothing that does not require as much flexibility/dexterity as for the glove, such as a jacket.

Cut and needle-stick resistance tests were performed on two types of inserts for comparison, for use in a glove. The cut resistance tests were carried out according to the European and French standard NF EN 388:2016 for protective gloves against mechanical risks. The needle-stick resistance test was carried out according to the American standard ASTM F2878 because the NF EN 388:2016 standard does not yet offer this type of test.

The two inserts are:
sample A: the material 100 in accordance with the invention: three layers, the pattern of the platelets is of the TRIHEX® type is inscribed in a circle of 4 mm radius, has a thickness of 0.7 mm, with a clearance between platelets of 1.0 mm, the platelets of each layer are made by 3D printing with PLA, and with a polyamide tulle trapped in the platelets of each layer; A layer of goat's leather simulates a 0.8 mm thick outer shell.
sample B: the SHARPMASTER 9014 UVEX glove from HEXARMOR, consisting of three layers of SUPERFABRIC™.

The glove in Sample B is one of the best performing gloves currently on the market.

The test results are shown in the table below:

TABLE 1

| | Performance | |
|---|---|---|
| | Cut test TDM | Needle resistance ASTM F2878-10 |
| | (in Newtons) | (in Newtons) |
| Sample A | >100 | 20.27 |
| Sample B | 70.2 | 10.279 |

The cut resistance is determined according to the ISO standard: 13997. The test, called a TDM cut test (an acronym for Tomodynamometer), determines the force applied to a blade on the sample to slice it. The higher the force required to slice the sample, the stronger its resistance to cutting. This test allows us to categorize gloves with very high resistance. The test was carried out on five items of each sample. The average of the five measurements per sample is listed in Table 1.

Needle-stick resistance is determined by ASTM F2878-10. The test determines the force required to pierce the sample with a 25-gauge needle. The higher the force required to pierce the sample, the stronger its resistance to needle sticking. The test was performed on three items of each sample, four measurements per item.

The average of the twelve measurements per sample is listed in Table 1.

No perforations on the samples A were noted.

Perforations on the samples B were noted.

The tests, both in terms of resistance to cutting and needle-sticks, show that sample A performs better than sample B.

A glove, or any other article of clothing, comprising the material 100 according to the invention, for example in the form of an insert, would present a significant gain in performance in terms of protection, in terms of needle-stick resistance, for its user.

FIG. 8 illustrates the example of the use of the material 100 according to the invention in a glove 600. The glove 600 shown in FIG. 8 is intended, in a non-restrictive way, for a right hand. The material 100 is shown in a dotted line because it is not visible from the outside of the glove.

The material 100 can be assembled to any type of glove. The material 100 can be assembled by sewing or gluing. The material 100 can cover all or part of the glove 600.

When the material 100 does not cover the entire glove, the glove may have several pieces of material 100, arranged at specific areas of the hand of the user that need to be specifically protected, for example the fingertips.

For example, the material 100 can be integrated as an insert in the glove, i.e. positioned between an outer coating, on the outer environment side, and a lining, on the hand side.

The material 100 can also be placed on a textile glove (or inside the textile glove) and then coated together with a protective coating.

The material 100 can also be placed between a knitted glove and a reinforcement sole, e.g. made of leather.

In an example of glove manufacturing, the material 100 can be cut in the shape of a hand, on the palm side of the hand for example, and attached to shells, in the shape of thimbles, each intended to receive one end of a finger of the hand. The shells are preferably made by 3D printing in a material configured to resist stick. A lining is attached to the material 100, with the lining intended to come against the palm of the hand to improve the user's comfort. Then the material 100/shells/lining assembly is threaded into a glove, forming an outer covering, in leather or coated material for example. The material is sandwiched between the outer glove and the lining. The shells, when the assembly is in the glove, have a dimension such that they are advantageously held by friction with the ends of the fingers of the glove. The shells, which are integral to the material, allow the material to be easily put on the glove. When the user puts on the glove, the tips of their fingers are simply positioned in the shells and the palm of the hand is facing the lining.

Such a glove 600, with the material according to the invention, and regardless of its manufacturing method, can be used by many workers, especially those in the collection and sorting of waste, horticulturists in public gardens.

The above description clearly illustrates that, by its various features and their advantages, the present invention achieves the objectives it had set for itself. In particular, the present invention makes it possible to obtain a material resistant to needle-sticks while guaranteeing flexibility.

1-8. (canceled)

9. A material comprising:
a superposition of at least three layers, a lower layer, at least one intermediate layer and an upper layer, each layer comprising:
a plurality of platelets arranged in a juxtaposed manner while forming a paving, with a clearance between said platelets;
a connector to join the plurality of platelets together;
said at least three layers being superposed on one another so that the plurality of platelets of one layer are offset with respect to the plurality of platelets of the other layers so as to remove all openings in the material; and
wherein each platelet of the upper layer comprises a local thickening at a level of an outer periphery of said each platelet.

10. The material of claim 9, wherein, for one layer of said at least three layers, the connector is a fabric and the plurality of platelets of said one layer are securely bonded to the fabric.

11. The material of claim 10, wherein the fabric is trapped within a thickness of a set of platelets.

12. The material of claim 9, wherein said at least three layers are fixedly secured together.

13. The material of claim 12, wherein the lower layer comprises studs arranged in some platelets of said plurality of platelets of the lower layer, and the other layers comprise through orifices to receive said studs.

14. The material of claim 9, wherein the plurality of platelets of one layer of said at least three layers are geometrically shaped as three hexagons, each hexagon joined together at a level of two adjacent edges.

15. The material of claim 9, wherein the plurality of platelets of said at least three layers are made by 3D printing.

16. An article of clothing comprising the material of claim 9.
